(19) United States
(12) Patent Application Publication
(10) Pub. No.: US 2024/0080926 A1
(43) Pub. Date: Mar. 7, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/238,535

(22) Filed: Aug. 28, 2023

(30) Foreign Application Priority Data
Sep. 3, 2022 (CN) 202211074420.5

(51) Int. Cl. H04W 76/20; H04W 28/06

(52) U.S. Cl. CPC H04W 76/20; H04W 28/06

(57) ABSTRACT

The present application discloses a method and device for wireless communications, comprising receiving a first signaling in RRC_CONNECTED state, as a response to receiving the first signaling, executing a first operation set, entering into RRC_INACTIVE state; receiving data through a first radio bearer in RRC_INACTIVE state; wherein the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer. The method proposed in the present application can ensure the quality of service reception.

### CROSS REFERENCE TO RELATED APPLICATIONS

This application claims the priority benefit of Chinese Patent Application No. 202211074420.5, filed on Sep. 3, 2022, the full disclosure of which is incorporated herein by reference.

### BACKGROUND

### Technical Field

The present application relates to transmission methods and devices in wireless communication systems, and in particular to a method and device for broadcast and groupcast services, power saving, and discontinuous reception in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). A work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). And a wide range of requests can be found in terms of Industrial Internet of Things (IIoT), Vehicular to X (V2X) and Device to Device (D2D), Unlicensed Spectrum communications, and monitoring on UE communication quality, network plan optimization, Non Terrestrial Network (NTN) and Terrestrial Network (TN), or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

The concepts, terms, and abbreviations used in the present application can refer to the 3GPP standard, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.321/38321-h10.zip
https://www.3gpp.org/ftp/Specs/archive/38_series/38.304/38304-h10.zip

### SUMMARY

Multicast and Broadcast Services (MBSs) are often used for video transmission, which occupies a large bandwidth and consumes a great amount of power. On the other hand, MBS may also be applied to a large number of IoT devices to reduce the consumption of network resources. Saving power is very important for IoT devices. Therefore, terminals using the MBS services have a general demand for power saving. One possible way to save power is to enter into RRC_INACTIVE state to receive MBS services when there are no other services. Receiving multicast services in RRC_INACTIVE state, especially continuously receiving MBS services from RRC_CONNECTED state to RRC_INACTIVE state, is a challenge that was not supported by previous protocols. The typical scenario mainly considered in existing technology is to receive services in RRC_CONNECTED state. After entering into RRC_INACTIVE state, a radio bearer is suspended to stop receiving services, and after entering into RRC_CONNECTED state again, a radio bearer is restored while a reception of services is also restored. From suspension to restoration, saving and restoring communication parameters and configurations is involved, comprising parameters related to header compression, such as header compression state. However, for MBS services that have been continuously received from RRC_CONNECTED state, it is meaningless to restore previously saved header compression state while restoring an RRC connection, as the header compression state may change during the reception process, restoring to a previous state is not only detrimental to reception, but may also cause service interruption due to a mismatch in header compression state. Therefore, how to ensure a normal reception of traditional services after the restoring of RRC connection without affecting the continuous reception of MBS services when entering RRC_INACTIVE state is a problem to be solved. The method proposed in the present application can solve this problem and also address more complex problems in actual systems. For example, a UE transmits an RRC connection recovery request only for an RAN-based Notification Area (RNA) update and does not enter into RRC_CONNECTED state. However, in the existing technology, a transmission of an RRC connection recovery request may lead to incorrect restoration of the header compression state.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. The method proposed in the present application can also be used to solve other problems in communications, such as the need to use unicast radio bearer reception in RRC_INACTIVE state, especially in scenarios where continuous reception using a unicast radio bearer is ensured from RRC_CONNECTED state to RRC_INACTIVE state.

The present application provides a method in a first node for wireless communications, comprising:
receiving a first signaling in RRC_CONNECTED state, as a response to receiving the first signaling, executing a first operation set, entering into RRC_INACTIVE state; receiving data through a first radio bearer in RRC_INACTIVE state;
herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, a problem to be solved in the present application comprises: how to better support communications in RRC_INACTIVE state, how to save power, how to better support receiving broadcast multicast services, how to receive broadcast and multicast services in RRC_INACTIVE state, and how to ensure the continuity of broadcast and multicast service reception; how to ensure the continuity of service reception from RRC_CONNECTED state to RRC_INACTIVE state, how to better support header compression, how to determine whether to save header compression-related-information based on a type of a radio bearer, and how to determine whether to save header compression-related-information based on whether to accept in RRC_INACTIVE state.

In one embodiment, advantages of the above method comprise: it can save electricity, improve service quality, support service continuity and receiving services in inactive state, thus avoiding service interruption and having better adaptability.

Specifically, according to one aspect of the present application, the first signaling is used to indicate receiving data through the first radio bearer set in RRC_INACTIVE state; the first radio bearer set comprises at least the first radio bearer.

Specifically, according to one aspect of the present application, only when data is received through the first radio bearer in RRC_INACTIVE state, the phrase that “when the first radio bearer is a multicast radio bearer, the first information does not comprise a header compression state for the first radio bearer” is valid.

Specifically, according to one aspect of the present application, a PDCP entity corresponding to the first radio bearer is configured with header compression, and a profile of the header compression configured to a PDCP entity corresponding to the first radio bearer is a profile other than no compression.

Specifically, according to one aspect of the present application, before receiving the first signaling, data is received through the first radio bearer in RRC_CONNECTED state.

Specifically, according to one aspect of the present application, any radio bearer in the first radio bearer set is a multicast radio bearer for multicast; a second radio bearer is a radio bearer other than the first radio bearer set, and the second radio bearer is a multicast radio bearer for broadcast; the first information does not comprise a header compression state for the first radio bearer.

Specifically, according to one aspect of the present application, a first message is transmitted, and the first message is used to request resuming an RRC connection; accompanying a transmission of the first message, second information is restored from the first inactive context, the second information comprises the first key;
herein, whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

Specifically, according to one aspect of the present application, the phrase that when the first radio bearer is a multicast radio bearer, the second information does not comprise a header compression state for the first radio bearer is valid only when the first radio bearer is in RRC_INACTIVE state.

Specifically, according to one aspect of the present application, a first indication is received, and the first indication is used to determine whether to stop receiving data through the first radio bearer; a header compression state for the first radio bearer is stored in a first inactive context.

Specifically, according to one aspect of the present application, the first node is a UE.

Specifically, according to one aspect of the present application, the first node is an IoT terminal.

Specifically, according to one aspect of the present application, the first node is a relay.

Specifically, according to one aspect of the present application, the first node is a vehicle terminal.

Specifically, according to one aspect of the present application, the first node is an aircraft.

The present application provides a first node for wireless communications, comprising:
a first receiver, receiving a first signaling in RRC_CONNECTED state, as a response to receiving the first signaling, executing a first operation set, entering into RRC_INACTIVE state; receiving data through a first radio bearer in RRC_INACTIVE state;
herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the present application has the following advantages over conventional schemes:
supporting receiving broadcast and/or multicast services in RRC_INACTIVE state, making it more power saving.
ensuring the continuity of service reception, allowing for a smooth transition from reception in RRC_CONNECTED state to a reception in RRC_INACTIVE state.
avoiding communication interruption incurred by the need to enter into RRC_CONNECTED state or initiating RRC continuous requests due to other communications in RRC_INACTIVE state.
solving the storage problem of information related to header compression.
after entering into RRC_CONNECTED state again from RRC_INACTIVE state, ensuring continuous reception of services.
supporting a suspension and continuation of broadcast and/or multicast services that are not received in RRC_INACTIVE state.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling, executing a first operation set, entering into RRC_INACTIVE state and receiving data through a first radio bearer in RRC_INACTIVE state according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of header compression state according to one embodiment of the present application;

FIG. 7 illustrates a schematic diagram of header compression state according to one embodiment of the present application;

FIG. 8 illustrates a schematic diagram of a first signaling being used to indicate receiving data through a first radio bearer in RRC_INACTIVE state according to one embodiment of the present application;

FIG. 9 illustrates a schematic diagram of a PDCP function according to one embodiment of the present application;

FIG. 10 illustrates a schematic diagram of a processor in a first node according to one embodiment of the present application;

FIG. 11 illustrates a schematic diagram of a processor in a first node according to one embodiment of the present application;

FIG. 12 illustrates a structure block diagram of a processor in a first node according to one embodiment of the present application;

FIG. 13 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a schematic diagram of receiving a first signaling, executing a first operation set, entering into RRC_INACTIVE state and receiving data through a first radio bearer in RRC_INACTIVE state according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101; executes a first operation set in step 102; enters into RRC_INACTIVE state in step 103, and receives data through a first radio bearer in RRC_INACTIVE state in step 104.
herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the first node is a User Equipment (UE).

In one embodiment, the first node is a Mobile Station (MS).

In one embodiment, bandwidth self-adaptation is supported in 5G NR; a subset of a total cell bandwidth of a cell is called a BWP; the base station implements bandwidth self-adaptation by configuring BWPs to the UE and telling the UE which of the configured BWPs is a currently active BWP.

In one embodiment, an SpCell of the first node refers to a PCell of the first node.

In one embodiment, an SpCell of the first node refers to a PSCell of the first node.

In one embodiment, a serving cell refers to a cell where a UE resides; executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state: enabling the UE to receive a system message from the PLMN or the SNPN; after registration, if the UE wishes to establish an RRC connection or continue a suspended RRC connection, the UE can achieve this by executing an initial access on a control channel of residing camping cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell; if a UE is only connected to one cell, then this cell is a main cell of UE. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, there can also be a Secondary Cell Group (SCG), where an SpCell refers to a PCell of an MCG or a Primary SCG Cell (PSCell) of an SCG; if it is not a dual connectivity operation, an SpCell refers to a PCell.

In one embodiment, a frequency at which a Secondary Cell (SCell) works is a sub-frequency.

In one embodiment, a Multi-Radio Dual Connectivity (MR-DC) refers to a dual connectivity between an E-UTRA and an NR node, or a dual connectivity between two NR nodes.

In one embodiment, In MR-DC, a radio access node providing a control-plane connection to the core network is a master node, and the master node may be a master eNB, a master ng-eNB, or a master gNB.

In one embodiment, an MCG refers to, in an MR-DC, a group of serving cells associated with a master node, comprising an SpCell, and optionally one or multiple SCells.

In one embodiment, in an MR-DC, a control plane connection to the core network is not provided, and a radio access node providing extra resources to the UE is a sub-node. The sub-node can be an en-gNB, a sub-ng-eNB or a sub-gNB.

In one embodiment, in an MR-DC, a group of serving cells associated with a sub-node is a Secondary Cell Group (SCG), comprising a SpCell and, optionally, one or multiple SCells.

In one embodiment, a PCell is an SpCell of an MCG.

In one embodiment, a PSCell is an SpCell of an SCG.

In one embodiment, an individual content of an information element is called a field.

In one embodiment, an information element is a structural element comprising one or multiple fields.

In one embodiment, an MRB is a radio bearer configured for MBS multicast or broadcast transmission.

In one embodiment, MBS is a PTM service, and for the specific definition, refer to 3GPP TS 23.247.

In one embodiment, PTP transmission refers to: a gNB independently transmits separate copies of MBS packets to each UE, which means that the gNB uses, comprising a C-RNTI, a UE-specific physical downlink control channel (PDCCH) scrambled by a UE-specific RNTI to schedule a UE-specific PDSCH, and the UE-specific physical downlink shared channel (PDSCH) is scrambled by the UE-specific RNTI.

In one embodiment, a PTM transmission refers to: a gNB transmits a copy of MBS data packets to a UE set, for example, a gNB schedules a group-common PDCCH using a group-common PDCCH scrambled by a group-common RNTI, and the group-common PDSCH is scrambled by the group-common RNTI.

In one embodiment, only PCell exists in RRC_INACTIVE state.

In one embodiment, a UE has complete communication function only in RRC_CONNECTED state.

In one embodiment, the first signaling comprises a MAC CE.

In one embodiment, the first signaling comprises an RRC signaling.

In one embodiment, the first signaling uses signaling radio bearer 1 (SRB1) for transmission.

In one embodiment, the first signaling comprises an RRCReconfiguration.

In one embodiment, the first signaling is or comprises an RRCRelease.

In one embodiment, the first signaling is used to suspend an RRC connection.

In one embodiment, after applying the first signaling, an RRC connection of the first node is not released.

In one embodiment, before receiving the first signaling, the first node is configured with at least one radio bearer.

In one embodiment, the first node executes an operation indicated by the first signaling 60 ms after receiving the first signaling or after the first signaling is successfully fed back by the protocol layer below the RRC of the first node.

In one embodiment, the first node executes the first operation set 60 ms after receiving the first signaling or after the first signaling is successfully fed back by the protocol layer below the RRC of the first node.

In one embodiment, the first signaling comprises a pending configuration.

In one embodiment, the first signaling indicates an RNTI used in RRC_INACTIVE state.

In one subembodiment of the above embodiment, a length of the RNTI used in RRC_INACTIVE state is greater than 16 bits.

In one subembodiment of the above embodiment, the RNTI used in the RRC_INACTIVE state comprises an I-RNTI.

In one embodiment, the first signaling indicates a paging cycle.

In one embodiment, the first signaling indicates an extended paging cycle.

In one embodiment, the first signaling indicates RAN to notify zone information.

In one embodiment, the first signaling indicates nextHopChainingCount.

In one embodiment, the nextHopChainingCount is used to generate key.

In one embodiment, the first signaling indicates a first configuration, and the first configuration is for small data transmission.

In one embodiment, a radio bearer involved in the first configuration is a data radio bearer (DRB) and/or a signaling radio bearer (SRB).

In one embodiment, the first signaling comprises a first field, and the first field is used to configure positioning in RRC_INACTIVE state.

In one embodiment, the first operation set comprises at least one operation.

In one embodiment, the first operation set comprises suspending all timers in a first timer set.

In one subembodiment of the embodiment, the first timer set comprises at least one of T380, T320, T316, T350, T346g, T331, T390, T420, T430, T319, T319a, or a timer related to MBS.

In one embodiment, the first operation set comprises starting at least one timer in a second timer set.

In one subembodiment of the embodiment, the second timer set comprises at least one of a timer related to MBS or T302.

In one embodiment, the first operation set comprises executing cell selection.

In one embodiment, the first operation set comprises executing frequency selection.

In one embodiment, the first operation set comprises resetting at least one parameter of a MAC.

In one embodiment, the first operation set comprises resetting partial not all parameters of a MAC.

In one embodiment, the first operation set comprises reestablishing an RLC entity of SRB1.

In one embodiment, the first operation set comprises suspending all SRBs other than SRB0.

In one embodiment, the first operation set comprises suspending all DRBs.

In one embodiment, the first operation set does not comprise suspending the first radio bearer.

In one embodiment, applying the first signaling will not cause suspending the first radio bearer.

In one embodiment, applying the first signaling will not cause suspending an MRB for broadcast.

In one embodiment, the first signaling indicates whether any radio bearer in a first radio bearer set is suspended.

In one embodiment, the first signaling indicates not suspending any radio bearer in a first radio bearer set.

In one embodiment, any radio bearer in the first radio bearer set is a radio bearer related to broadcast or groupcast.

In one embodiment, any radio bearer in the first radio bearer set is a multicast MRB received in RRC_INACTIVE state.

In one embodiment, any radio bearer in the first radio bearer set is a multicast MRB.

In one embodiment, the first radio bearer belongs to the first radio bearer set.

In one embodiment, the first radio bearer is unrelated to SDT.

In one embodiment, the meaning of the phrase of executing a first operation set is executing each operation in the first operation set.

In one embodiment, the first inactive context is context in RRC_INACTIVE state.

In one embodiment, when the UE enters into RRC_INACTIVE state from RRC_CONNECTED state, information needed to be saved is stored in the first inactive context.

In one embodiment, the first inactive context is a UE Inactive AS Context.

In one embodiment, any moment can only be in one RRC state.

In one embodiment, the behavior of entering into RRC_INACTIVE state means leaving RRC_CONNECTED state.

In one embodiment, the behavior of entering into RRC_INACTIVE state means releasing an RRC connection.

In one embodiment, when the first node enters into RRC_INACTIVE state from RRC_CONNECTED state, only content comprised in the first information is stored.

In one embodiment, when the first node enters into RRC_INACTIVE state from RRC_CONNECTED state, all the stored information belongs to the first information.

In one embodiment, the first key comprises a key used for encrypting the SRB1.

In one embodiment, the first key comprises a key for the control plane.

In one embodiment, the first key comprises a key for user plane.

In one embodiment, the first key comprises KgNB.

In one embodiment, the first key comprises KRRCint.

In one embodiment, the first key comprises KRRCenc.

In one embodiment, the meaning of the phrase that the first key is used for encrypting the first signaling comprises: the first key is used to generate scrambling that encrypt the first signaling.

In one embodiment, the meaning of the phrase that the first key is used for encrypting the first signaling comprises: the first key is an input parameter of encryption function that encrypts the first signaling.

In one embodiment, the meaning of the phrase that the first key is used for encrypting the first signaling comprises: the first key is used to generate a key that encrypts the first signaling.

In one embodiment, the first radio bearer does not use encryption.

In one embodiment, the first radio bearer does not use integrity protection.

In one embodiment, the meaning of the phrase of a multicast radio bearer comprises a broadcast radio bearer.

In one embodiment, the meaning of the phrase of a multicast radio bearer comprises a multicast radio bearer.

In one embodiment, the meaning of the phrase of a multicast radio bearer comprises an MRB for broadcast.

In one embodiment, the meaning of the phrase of a multicast radio bearer comprises an MRB for multicast.

In one embodiment, the meaning of the phrase of a multicast radio bearer does not comprise an MRB for broadcast.

In one embodiment, the meaning of the phrase of a multicast radio bearer does not comprise an MRB for multicast.

In one embodiment, an MRB is an MBS Radio Bearer.

In one embodiment, an MBS specifically refers to a non-unicast service.

In one embodiment, an MBS specifically refers to a broadcast service.

In one embodiment, an MBS specifically refers to a multicast service.

In one embodiment, an MBS specifically refers to a broadcast and multicast service.

In one embodiment, an MBS is a Multicast Broadcast Service.

In one embodiment, the meaning of the phrase of receiving data through a first radio bearer in RRC_INACTIVE state comprises: receiving an MBS through a first radio bearer in RRC_INACTIVE state.

In one embodiment, the meaning of the phrase of receiving data through a first radio bearer in RRC_INACTIVE state comprises: receiving a first service through a first radio bearer in RRC_INACTIVE state, the first service being a non-unicast service.

In one embodiment, the first service is a broadcast service.

In one embodiment, the first service is a multicast service.

In one embodiment, the first service is associated with a first Temporary Mobile Group Identity (TMGI).

In one embodiment, the first service is associated with an identity related to broadcast groupcast.

In one embodiment, a G-RNTI is used to receive data through a first radio bearer in RRC_INACTIVE state.

In one embodiment, a Group Configured Scheduling RNTI (G-CS-RNTI) is used to receive data through a first radio bearer in RRC_INACTIVE state.

In one embodiment, RNTI is a Radio Network Temporary Identifier.

In one embodiment, the first information comprises a header compression state for any suspended radio bearer.

In one embodiment, a radio bearer suspended during an execution of the first signaling comprises at least SRB1.

In one embodiment, the first information comprises a header compression state for any radio bearer that is suspended during an execution of the first signaling.

In one embodiment, the first information does not comprise a header compression state for a radio bearer that is not suspended during an execution of the first signaling.

In one embodiment, the first radio bearer belongs to a radio bearer that is not suspended during an execution of the first signaling.

In one embodiment, the first radio bearer set belongs to a radio bearer that is not suspended during an execution of the first signaling.

In one embodiment, a radio bearer that is not suspended during an execution of the first signaling comprises at least the first radio bearer.

In one embodiment, whether the header compression state of the first radio bearer is saved is related to whether the first radio bearer is suspended.

In one embodiment, whether the first information comprises a header compression state for a first radio bearer is related to whether the first radio bearer is suspended.

In one embodiment, the meaning of the phrase of a header compression for the first radio bearer comprises: a header compression state of a PDCP of the first radio bearer.

In one embodiment, the meaning of the phrase of a header compression for the first radio bearer comprises: a header compression state of a PDCP entity corresponding to the first radio bearer.

In one embodiment, the meaning of the phrase of a header compression for the first radio bearer comprises: a header compression state of a header compression used by a PDCP entity corresponding to the first radio bearer.

In one embodiment, the meaning of the phrase of a header compression for the first radio bearer comprises: a state of header compression algorithm or header compression sub-protocol of a PDCP entity corresponding to the first radio bearer.

In one embodiment, the header compression comprises Robust Header Compression (RoHC).

In one embodiment, the header compression comprises Ethernet Header Compression (EHC).

In one embodiment, the first radio bearer is configured to use RoHC.

In one embodiment, a PDCP entity corresponding to the first radio bearer is configured to use RoHC.

In one embodiment, the header compression state comprises RoHC state.

In one embodiment, the header compression state comprises a context state of header compression.

In one embodiment, the header compression state comprises a decompression state of header compression.

In one embodiment, a radio bearer only has one corresponding PDCP entity.

In one embodiment, a PDCP corresponding to the first radio bearer only has one header compressor instance.

In one embodiment, a PDCP corresponding to the first radio bearer only has one decompressor instance for header compression.

In one embodiment, a radio bearer in the present application is unrelated to Dual Active Protocol Stack (DAPS).

In one embodiment, the meaning of the phrase that the first information comprises a header compression for the first radio bearer comprises: storing a header compression state for the first radio bearer.

In one embodiment, the meaning of the phrase that the first information comprises a header compression for the first radio bearer comprises: storing a header compression state for the first radio bearer during an execution of the first signaling.

In one embodiment, the meaning of the phrase that the first information comprises a header compression for the first radio bearer comprises: storing a header compression state for the first radio bearer when entering into RRC_INACTIVE state from RRC_CONNECTED state.

In one embodiment, the meaning of the phrase that the first information does not comprise a header compression for the first radio bearer comprises: not storing a header compression state for the first radio bearer.

In one embodiment, the meaning of the phrase that the first information does not comprise a header compression for the first radio bearer comprises: not storing a header compression state for the first radio bearer during an execution of the first signaling.

In one embodiment, the meaning of the phrase that the first information does not comprise a header compression for the first radio bearer comprises: not storing a header compression state for the first radio bearer when entering into RRC_INACTIVE state from RRC_CONNECTED state.

In one embodiment, RRC_INACTIVE state and RRC_IDLE state are different RRC states.

In one subembodiment of the above embodiment, a UE in RRC_INACTIVE state can quickly store an RRC connection through an RRC continue request, while a UE in RRC_IDLE state needs to re-establish an RRC connection to enter into RRC_CONNECTED state.

In one subembodiment of the above embodiment, a UE in RRC_INACTIVE state needs periodic state updates.

In one embodiment, the header compression comprises RoHC.

In one embodiment, the header compression comprises header compression for Ethernet.

In one embodiment, the first radio bearer is an MRB for multicast.

In one embodiment, the first radio bearer is an MRB for broadcast.

In one embodiment, an MRB for multicast is for multicast services.

In one embodiment, an MRB for broadcast is for broadcast services.

In one embodiment, the meaning of the phrase of when the first radio bearer is not a multicast radio bearer comprises: when the first radio bearer is a DRB.

In one embodiment, the meaning of the phrase of when the first radio bearer is not a multicast radio bearer comprises: when the first radio bearer is an SRB.

In one embodiment, the meaning of the phrase of when the first radio bearer is not a multicast radio bearer comprises: when the first radio bearer is an SRB other than SRB0.

In one embodiment, the first radio bearer is unrelated to sidelink communications.

In one embodiment, the first radio bearer is a radio bearer between the network and the first node.

In one embodiment, the first signaling is used to indicate receiving data through the first radio bearer set in RRC_INACTIVE state; the first radio bearer set comprises at least the first radio bearer.

In one embodiment, the first radio bearer set does not comprise SRB0.

In one embodiment, the first radio bearer set does not comprise a radio bearer related to SDT.

In one embodiment, the meaning of the phrase that the first signaling is used to indicate receiving data through the first radio bearer set in RRC_INACTIVE state comprises: the first signaling indicates not suspending the first radio bearer set.

In one embodiment, the meaning of the phrase that the first signaling is used to indicate receiving data through the first radio bearer set in RRC_INACTIVE state comprises: the first signaling indicates not suspending any radio bearer in the first radio bearer set.

In one embodiment, only when data is received through the first radio bearer in RRC_INACTIVE state, the phrase that “when the first radio bearer is a multicast radio bearer, the first information does not comprise a header compression state for the first radio bearer” is valid.

In one embodiment, the meaning of the phrase of receiving data through the first radio bearer in RRC_INACTIVE state comprises: the first signaling comprises configuration information for receiving data through the first radio bearer in RRC_INACTIVE state.

In one embodiment, the meaning of the phrase of receiving data through the first radio bearer in RRC_INACTIVE state comprises: the first signaling indicates not suspending the first radio bearer.

In one embodiment, when the first node does not receive data through the first radio bearer in RRC_INACTIVE state, the first information comprises a header compression state for the first radio bearer.

In one embodiment, the meaning of the phrase that when the first node does not receive data through the first radio bearer in RRC_INACTIVE state comprises: the first signaling indicates suspending the first radio bearer.

In one embodiment, the meaning of the phrase that when the first node does not receive data through the first radio bearer in RRC_INACTIVE state comprises: the first signaling does not indicate not suspending the first radio bearer.

In one embodiment, the meaning of the phrase that when the first node does not receive data through the first radio bearer in RRC_INACTIVE state comprises: the first radio bearer is suspended.

In one embodiment, whether or not data is received through the first radio bearer in RRC_INACTIVE state, the phrase that when the first radio bearer is a multicast radio bearer, the first information does not comprise a header compression state for the first radio bearer is valid.

In one embodiment, a PDCP entity corresponding to the first radio bearer is configured with header compression, and a profile of the header compression configured to a PDCP entity corresponding to the first radio bearer is a profile other than no compression.

In one embodiment, header compression configured to the first radio bearer is used for compressing at least an IP header.

In one embodiment, the first signaling is used to configure header compression of the first radio bearer.

In one embodiment, the first signaling is used to configure header compression of a PDCP entity corresponding to the first radio bearer.

In one embodiment, the first signaling is used for not changing header compression configuration of the first radio bearer.

In one embodiment, the first signaling is used for not changing header compression configuration of a PDCP entity corresponding to the first radio bearer.

In one embodiment, the first signaling indicates continuing to use RoHC for the first radio bearer.

In one embodiment, an identity of the profile of the header compression configured to a PDCP entity corresponding to the first radio bearer is a value other than 0x0000.

In one embodiment, whether the first information comprises a header compression state for the first radio bearer is unrelated to the profile of the header compression configured to a PDCP corresponding to the first radio bearer.

In one embodiment, whether the first information comprises a header compression state for the first radio bearer is related to the profile of the header compression configured to a PDCP corresponding to the first radio bearer.

In one embodiment, whether the first information comprises a header compression state for the first radio bearer is related to an identity of the profile of header compression configured to a PDCP entity corresponding to the first radio bearer, when an identity of the profile of the header compression configured to a PDCP entity corresponding to the first radio bearer is 0x0000, the first information comprises a header compression state for the first radio bearer; when an identity of the profile of the header compression configured to a PDCP identity corresponding to the first radio bearer is not 0x0000, the first information does not comprise a header compression state for the first radio bearer.

In one embodiment, the first node, before receiving the first signaling, receives data through the first radio bearer in RRC_CONNECTED state.

In one embodiment, the meaning of the phrase of before receiving the first signaling, in RRC_CONNECTED state, receiving data through the first radio bearer comprises: before receiving the first signaling, receiving the first service through the first radio bearer in RRC_CONNECTED state.

In one embodiment, the meaning of the phrase of before receiving the first signaling, in RRC_CONNECTED state, receiving data through the first radio bearer comprises: the first node receives the first service through the first radio bearer before receiving the first signaling and after entering into RRC_INACTIVE state.

In one embodiment, the meaning of the phrase of before receiving the first signaling, in RRC_CONNECTED state, receiving data through the first radio bearer comprises: the first node receives a same first service through the first radio bearer before receiving the first signaling and after entering into RRC_INACTIVE state.

In one embodiment, the meaning of the phrase of before receiving the first signaling, in RRC_CONNECTED state, receiving data through the first radio bearer comprises: the first node receives a session of a same first service through the first radio bearer before receiving the first signaling and after entering into RRC_INACTIVE state.

In one embodiment, the meaning of the phrase of before receiving the first signaling, in RRC_CONNECTED state, receiving data through the first radio bearer comprises: the first node, before receiving the first signaling and after entering into RRC_INACTIVE state, does not change a session or flow received through the first radio bearer.

In one embodiment, the first signaling does not change a mapping of a QoS flow to the first radio bearer.

In one embodiment, the first signaling cannot change a mapping of a QoS flow to the first radio bearer.

In one embodiment, any radio bearer in the first radio bearer set is a multicast radio bearer for multicast.

In one embodiment, a second radio bearer is a radio bearer other than the first radio bearer set, and the second radio bearer is for broadcast.

In one embodiment, the second radio bearer is an MRB for broadcast.

In one embodiment, the first information does not comprise a header compression state for the first radio bearer.

In one embodiment, the second radio bearer is not suspended during the application of the first signaling.

In one embodiment, the second radio bearer is used to bear broadcast services.

In one embodiment, the second radio bearer is configured to use header compression.

In one embodiment, the second radio bearer is configured to use header compression, and the profile of header compression is profile other than non-compression.

In one embodiment, the second radio bearer is configured to use header compression, and an identity of a profile of the header compression is an identity other than 0x0000.

In one embodiment, the first radio bearer is a radio bearer other than an SRB.

In one embodiment, any radio bearer comprised in the first radio bearer set is a radio bearer other than an SRB.

In one embodiment, the first information comprises a mapping criterion from a QoS flow to a DRB.

In one embodiment, the first information comprises a mapping criterion from a QoS flow to an MRB.

In one embodiment, the first information comprises a mapping criteria from a QoS flow to an XRB.

In one embodiment, the first information comprises a C-RNTI.

In one embodiment, the first information comprises a cell identity of a PCell.

In one embodiment, the first information comprises a physical cell identity of a PCell.

In one embodiment, the first information comprises content of spCellConfigCommon in ReconfigurionWithSync of a PSCell of the first node.

In one embodiment, the first information comprises servingCellConfigCommonSIB.

In one embodiment, the first information comprises information related to relay.

In one embodiment, the first information comprises an application layer measurement configuration.

In one embodiment, the first radio bearer is a radio bearer other than an SRB0.

In one embodiment, the first radio bearer is a radio bearer used for transmitting data.

In one embodiment, the phrase that when the first radio bearer is not a multicast radio bearer, the first information comprising a header compression state for the first radio bearer is only valid when an execution of the first signaling suspends the first radio bearer.

In one subembodiment of the embodiment, all unicast radio bearers other than SRB0 are suspended when the first signaling is executed.

In one subembodiment of the embodiment, SRB0 does not use header compression.

In one subembodiment of the embodiment, all MRBs for broadcast are not suspended when the first signaling is executed.

In one embodiment, the phrase that when the first radio bearer is a multicast radio bearer, the first information not comprising a header compression state for the first radio bearer is valid only when an execution of the first signaling does not suspend the first radio bearer.

### Embodiment 2

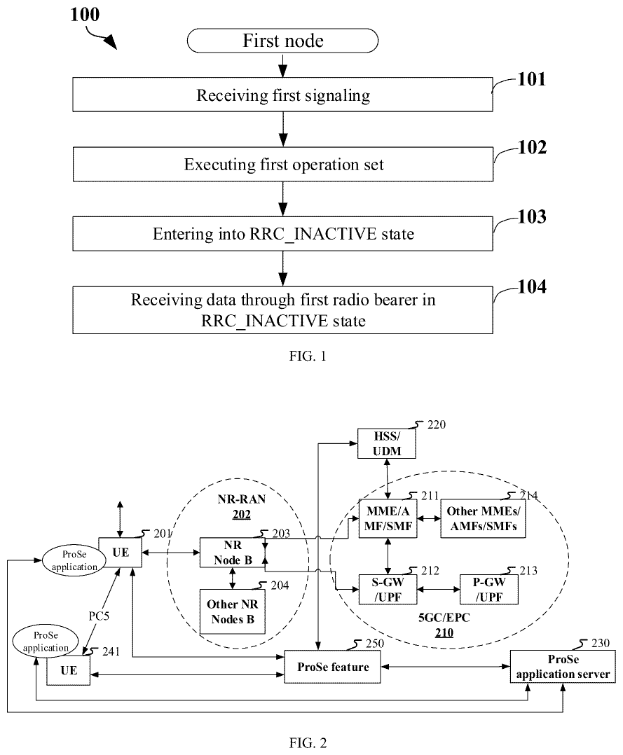

Embodiment 2 illustrates a schematic diagram of a network architecture according to one embodiment of the present application, as shown in FIG. 2. FIG. 2 is a diagram illustrating a V2X communication architecture of 5G NR, Long-Term Evolution (LTE), and Long-Term Evolution Advanced (LTE-A) systems. The 5G NR or LTE network architecture may be called a 5G System/Evolved Packet System (5GS/EPS) 200 or other appropriate terms. The V2X communication architecture in Embodiment 2 may comprise a UE 201, a UE 241 in communication with UE 201, an NG-RAN 202, a 5G Core Network/Evolved Packet Core (5GC/EPC) 210, a Home Subscriber Server (HSS)/Unified Data Management (UDM) 220, a ProSe feature 250 and a ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS). If near-field communication (prose) is involved, the network architecture can also comprise network elements related to near-field communications, such as ProSe function 250, Pro Se application server 230, etc. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the first node in the present application is a UE 201.

In one embodiment, a serving base station of the first node in the present application is a gNB 203.

In one embodiment, a radio link between the UE 201 and the NR node B is an uplink.

In one embodiment, a radio link between the NR node B and the UE 201 is a downlink.

In one embodiment, the UE 201 supports relay transmission.

In one embodiment, the UE 201 supports broadcast and multi-cast services.

In one embodiment, the UE 201 does not support relay transmission.

In one embodiment, the UE 201 supports multi-TRP transmission.

In one embodiment, the UE 201 is a vehicle comprising a car.

In one embodiment, the gNB 203 is a base station.

In one embodiment, the gNB 203 is a base station supports multi-TRP.

In one embodiment, the gNB 203 is a base station supporting broadcast multicast services.

In one embodiment, the gNB 203 is a flight platform.

In one embodiment, the gNB 203 is satellite equipment.

### Embodiment 3

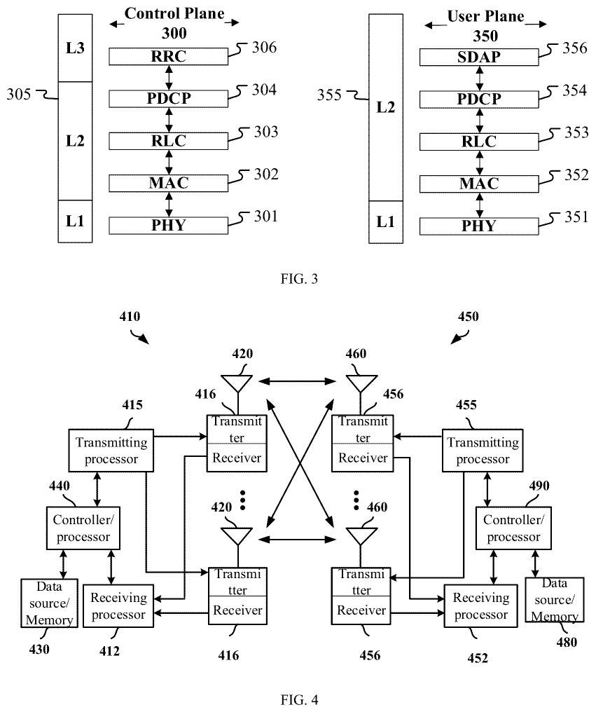

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). A radio bearer is an interface or service provided by the PDCP protocol layer to the higher layer.

In one embodiment, the radio protocol architecture in FIG. 3 is applicable to the first node in the present application.

In one embodiment, the first signaling in the present application is generated by the RRC 306.

In one embodiment, the first message in the present application is generated by the RRC 306.

In one embodiment, the first indication in the present application is generated by the PHY 301 or MAC 302 or RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor. The first communication device 450 at least: receives a first signaling in RRC_CONNECTED state, as a response to receiving the first signaling, executes a first operation set, enters into RRC_INACTIVE state; receives data through a first radio bearer in RRC_INACTIVE state; herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the first communication device 450 comprises: a memory that stores a computer readable instruction program. The computer readable instruction program generates an action when executed by at least one processor. The action includes: receiving a first signaling in RRC_CONNECTED state, as a response to receiving the first signaling, executing a first operation set, entering into RRC_INACTIVE state; receiving data through a first radio bearer in RRC_INACTIVE state; herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the first communication device 450 is a relay.

In one embodiment, the second communication device 410 is a base station.

In one embodiment, the receiver 456 (including the antenna 460), the receiving processor 452 and the controller/processor 490 are used to receive the first signaling in the present application.

In one embodiment, the receiver 456 (including the antenna 460), the receiving processor 452 and the controller/processor 490 are used to receive the first indication in the present application.

In one embodiment, the transmitter 456 (including the antenna 460), the transmitting processor 455 and the controller/processor 490 are to transmit the first message in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations and steps in F51 are optional.

The first node U01 receives a first signaling in step S5101; receives data through a first radio bearer in RRC_INACTIVE state in step S5102; receives a first indication in step S5103; transmits a first message in step S5104. The second node N02 transmits a first signaling in step S5201; transmits a first indication in step S5202;

receives a first message in step S5203.

In embodiment 5, the first node U01 receives a first signaling in RRC_CONNECTED state, as a response to receiving the first signaling, executes a first operation set, enters into RRC_INACTIVE state; receives data through a first radio bearer in RRC_INACTIVE state;
herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the second node N02 is a serving cell of the first node U01.

In one embodiment, the second node N02 is a PCell of the first node U01.

In one embodiment, the second node N02 is an SpCell of the first node U01.

In one embodiment, the second node N02 is a PSCell of the first node U01.

In one embodiment, the second node N02 is a base station.

In one embodiment, the second node N02 is a DU.

In one embodiment, the first signaling is transmitted through unicast.

In one embodiment, an interface between the first node U01 and the second node U02 is a Uu interface.

In one embodiment, in step S5101, there still exits a mapped broadcast or multicast flow on the first radio bearer.

In one embodiment, after executing the first signaling, there still exists a mapped multicast flow on the first radio bearer.

In one embodiment, after executing the first signaling, the first radio bearer is not suspended.

In one embodiment, after executing the first signaling, the first radio bearer is not released.

In one embodiment, after executing S5101 and before step S5102, the first node U01 is in RRC_INACTIVE state.

In one embodiment, the target signaling is an RRC message.

In one embodiment, the first signaling is a last unicast RRC signaling received by the first node U01 in RRC_CONNECTED state.

In one embodiment, an execution of the first signaling leads to a re-establishment of the first radio bearer.

In one embodiment, an execution of the first signaling will not lead to a re-establishment of the first radio bearer.

In one embodiment, the first signaling does not indicate re-establishing the first radio bearer.

In one embodiment, an execution of the first signaling leads to a re-establishment of an RRC connection.

In one embodiment, an execution of the first signaling will not lead to a re-establishment of an RRC connection.

In one embodiment, the first signaling does not indicate re-establishing an RRC connection.

In one embodiment, before receiving the first signaling, the first node U01 receives a first service through a radio bearer other than the first radio bearer; after executing the first signaling, the first node U01 receives the first service through the first radio bearer in RRC_INACTIVE state.

In one embodiment, the first signaling comprises a configuration of an RLC entity or an RLC bearer associated with the first radio bearer.

In one embodiment, the first indication is a signaling.

In one embodiment, the first indication comprises an RRC message.

In one embodiment, the first indication comprises a System Information Block (SIB) message.

In one embodiment, the first indication is transmitted through the method of broadcast or multicast.

In one embodiment, the first indication is received in RRC_INACTIVE state.

In one embodiment, the first indication comprises downlink control information.

In one embodiment, the first indication is a physical-layer signaling.

In one embodiment, the first indication is a MAC-layer control signaling.

In one embodiment, the first indication is an NAS signaling.

In one embodiment, the first indication can also be generated internally by the first node UOL

In one embodiment, the first indication is used to determine stopping receiving data through the first radio bearer.

In one embodiment, the first node U01 stores header compression state for the first radio bearer in the first inactive context.

In one embodiment, the first node U01 only has one UE Inactive AS (access stratum) Context.

In one embodiment, the behavior of receiving a first indication comprises: receiving the first indication from the physical layer, the first indication being generated by a physical layer of the first node UO 1.

In one embodiment, the behavior of receiving a first indication comprises: receiving the first indication from a MAC layer, the first indication being generated by a MAC layer of the first node UO 1.

In one embodiment, the behavior of stopping receiving data through the first radio bearer triggers storing a header compression state for the first radio bearer in a first inactive context.

In one embodiment, accompanying the behavior of stopping receiving data through the first radio bearer, the first node stores a header compression state for the first radio bearer in a first inactive context.

In one embodiment, accompanying the behavior of stopping receiving data through the first radio bearer, the first node suspends the first radio bearer.

In one embodiment, the first indication is used to indicate an end of the first service.

In one embodiment, the first indication is used to indicate a stopping or pending of the first service.

In one embodiment, the first indication is used to indicate that the first service will not be transmitted for a long time.

In one embodiment, the first indication is used to indicate that failure occurs in the first node U01.

In one embodiment, the first indication is used to indicate that cell reselection occurs in the first node U01.

In one embodiment, the first indication is used to indicate that PCell change occurs in the first node U01.

In one embodiment, the first indication is used to indicate that the first service is unavailable or is not transmitted.

In one embodiment, the first message is used to request resuming an RRC connection.

In one embodiment, the first node U01, accompanying a transmission of the first message, restores second information from the first inactive context, and the second information comprises the first key.

In one embodiment, whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

In one embodiment, whether the second information comprises a header compression state for the first radio bearer is related to whether the first radio bearer is suspended; when the first radio bearer is suspended, the second information comprises a header compression state for the first radio bearer; when the first radio bearer is not suspended, the second information does not comprise a header compression state for the first radio bearer.

In one embodiment, the first message comprises an RRC message.

In one embodiment, the first message is not encrypted.

In one embodiment, the first message is transmitted through SRB0.

In one embodiment, the first message is transmitted through a Common Control Channel (CCCH).

In one embodiment, the first message is transmitted through a Common Control Channel 1 (CCCH1).

In one embodiment, the first message comprises an RRCResumeRequest.

In one embodiment, the first message comprises an RRCResumeRequest1.

In one embodiment, a transmission of the first message is for a small data transmission.

In one embodiment, a transmission of the first message is for RNA update.

In one embodiment, a transmission of the first message is due to an expiration of a timer.

In one embodiment, a transmission of the first message is for entering into RRC_CONNECTED state.

In one embodiment, a transmission of the first message is not for entering into RRC_CONNECTED state.

In one embodiment, after step S5104, the first message receives an RRCReject message.

In one embodiment, after step S5104, the first message receives an RRCRelease message.

In one embodiment, after step S5104, the first message receives an RRCSetup message.

In one embodiment, after step S5104, the first message receives an RRCResume message.

In one embodiment, the second information does not comprise a header compression state for any radio bearer in the first radio bearer set; any radio bearer in the first radio bearer set is an MRB.

In one embodiment, the second information does not comprise a header compression state for any radio bearer in the first radio bearer set; any radio bearer in the first radio bearer set is an MRB for multicast.

In one embodiment, the second information does not comprise a header compression state for any radio bearer in the first radio bearer set; any radio bearer in the first radio bearer set is an MRB for broadcast.

In one embodiment, the second information does not comprise a header compression state for any radio bearer in the first radio bearer set; any radio bearer in the first radio bearer set is an MRB for multicast or broadcast.

In one embodiment, the second information does not comprise a header compression state for any radio bearer in the first radio bearer set; any radio bearer in the first radio bearer set is not suspended.

In one embodiment, the second information does not comprise a header compression state for any radio bearer in the first radio bearer set; any radio bearer in the first radio bearer set is in active state.

In one embodiment, the first radio bearer set does not comprise SRB0.

In one embodiment, the first node transmits the first message in RRC_INACTIVE state.

In one embodiment, the first key is used to decrypt a feedback message for the first message.

In one embodiment, whether the second information comprises a header compression state for the first radio bearer is related to a purpose or triggering reason of the first message, when the first message is transmitted for entering into RRC_CONNECTED state, the second information comprises a header compression state for the first radio bearer; when the first message is transmitted not for entering into RRC_CONNECTED state, the second information does not comprise a header compression state for the first radio bearer.

In one embodiment, after step S5102, as a response to or accompanying entering into RRC_CONNECTED state, the first node U01 restores a header compression state for the first radio bearer.

In one embodiment, after step S5102, as a response to receiving a signaling entering into RRC_CONNECTED state, the first node U01 restores a header compression state for the first radio bearer.

### Embodiment 6

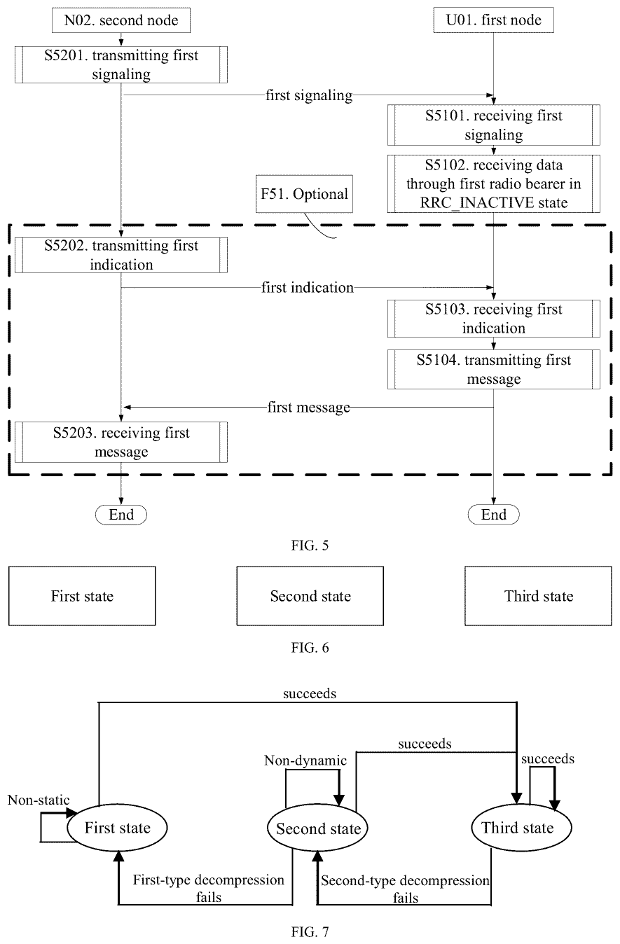

Embodiment 6 illustrates a schematic diagram of header compression state according to one embodiment of the present application, as shown in FIG. 6.

In one embodiment, FIG. 6 in the present application is applicable to a state of the compressor of the header compression.

In one embodiment, FIG. 6 in the present application is applicable to a state of the decompressor of the header compression.

In one embodiment, header compression state comprises at least one state.

Typically, header compression state comprises three states.

In one embodiment, the header compression state in the present application is for a unidirectional header compression protocol or header compression mode.

In one embodiment, the header compression state in the present application is also applicable to bidirectional header compression protocol or header compression mode.

In one embodiment, when the first radio bearer is an MRB, the header compression protocol is unidirectional header compression.

In one embodiment, the first operation set comprises setting header compression of a PDCP corresponding to the first radio bearer from bidirectional header compression to unidirectional header compression.

In one embodiment, the first operation set comprises setting header compression of a PDCP corresponding to the first radio bearer as unidirectional header compression.

In one embodiment, the first operation set comprises re-establishing a PDCP corresponding to the first radio bearer.

In one embodiment, header compression state of a compressor comprises: IR, FO, SO.

In one subembodiment of the above embodiment, the IR, the FO, and the SO respectively correspond to a first state, a second state, and a third state in FIG. 6.

In one embodiment, the meaning of IR is Initialization/Refresh.

In one embodiment, the meaning of FO is First Order.

In one embodiment, the meaning of SO is Second Order.

In one embodiment, header compression state of a decompressor respectively comprises: no context, static context, full context.

In one subembodiment of the above embodiment, the no context, the static context, and the full context respectively correspond to a first state, a second state, and a third state in FIG. 6.

In one embodiment, the first state and the second state can transit to each other.

In one embodiment, the first state and the third state can transit to each other.

In one embodiment, the second state and the third state can transit to each other.

In one embodiment, the transition relation between a first state, a second state, and a third state is related to whether it is for the compressor or the decompressor.

In one embodiment, compressor of header compression works at the transmitting end.

In one embodiment, decompressor of header compression works at the receiving end.

In one embodiment, the working efficiency of different header compression states varies.

In one embodiment, header compression of the first radio bearer uses a unidirectional mode.

In one embodiment, at a same time, a state of the decompressor can only be one state.

In one embodiment, at a same time, a state of the decompressor can only be one of the first state, the second state, or the third state.

In one embodiment, at a same time, a state of the compressor can only be one state.

In one embodiment, at a same time, a state of the compressor can only be one of the first state, the second state, or the third state.

In one embodiment, the first information only comprises a state of a decompressor.

In one embodiment, the first information only comprises a state of a compressor.

In one embodiment, the first information comprises a state of a decompressor and a state of a compressor.

### Embodiment 7

Embodiment 7 illustrates a schematic diagram of header compression state according to one embodiment of the present application, as shown in FIG. 7.

FIG. 7 illustrates the state and state transition of a unidirectional mode decompressor. FIG. 7 comprises three header compression states, respectively a first state, a second state, and a third state.

For areas not specified in embodiments, please refer to IETF RFC 3095: https://www.rfc-editor.org/rfc/rfc3095.

For areas not specified in embodiments, please refer to IETF RFC 4815: https://www.rfc-editor.org/rfc/rfc4815.

For areas not specified in embodiments, please refer to IETF RFC 5795: https://www.rfc-editor.org/rfc/rfc5795.

For areas not specified in embodiments, please refer to IETF RFC 6846: https://www.rfc-editor.org/rfe/rfe6848.

For areas not specified in embodiments, please refer to IETF RFC 5225: https://www.rfc-editor.org/rfc/rfc5225.

In one embodiment, the first state is no context.

In one embodiment, the second state is a static context.

In one embodiment, the third state is a full context.

In one embodiment, in a third state, if decompression or reception is correct all the time, it remains in the third state.

In one embodiment, in a third state, even if decompression or reception is correct all the time, it periodically returns to other states.

In one embodiment, in a third state, when k1 second-type decompression(s) fails(fail), it migrates to the second state.

In one subembodiment of the embodiment, the second-type decompression failure is for all data packets.

In one subembodiment of the embodiment, the second-type decompression failure is for partial data packets.

In one subembodiment of the embodiment, the k1 of the second-type decompression failure is configured or pre-configured.

In one subembodiment of the embodiment, the k1 of the second-type decompression failure is fixed.

In one subembodiment of the embodiment, the k1 of the second-type decompression failure is a threshold.

In one embodiment, in a second state, when k2 first-type decompression(s) fails(fail), it remains in the second state.

In one embodiment, in a second state, when k2 first-type decompression(s) fails(fail), it migrates to the first state.

In one subembodiment of the embodiment, the first-type decompression failure is for all data packets.

In one subembodiment of the embodiment, the first-type decompression failure is for partial data packets.

In one subembodiment of the embodiment, the first-type decompression failure is for specific data packets.

In one subembodiment of the embodiment, the k2 of the first-type decompression failure is configured or pre-configured.

In one subembodiment of the embodiment, the k2 of the first-type decompression failure is fixed.

In one subembodiment of the embodiment, the k2 of the first-type decompression failure is a threshold.

In one embodiment, in a second state, when the de-compression is successful, it migrates to the third state.

In one embodiment, in a second state, when a specific data packet is received, it migrates to the third state.

In one embodiment, in a second state, when the de-compression of a specific data packet is successful, it migrates to the third state.

In one embodiment, in a second state, when a specific data packet is not received, it remains in the second state.

In one embodiment, the meaning of non-dynamic is to continue being in the second state.

In one embodiment, in a first state, when a specific type of data packet is not received, it continues being in the first state.

In one embodiment, in a first state, when a specific type of data packet is received, it migrates to the third state.

In one embodiment, in a first state, when a specific type of data packet is received and is successfully de-compressed, it migrates to the third state.

In one embodiment, the meaning of being non-static is to continue being in the first state.

### Embodiment 8

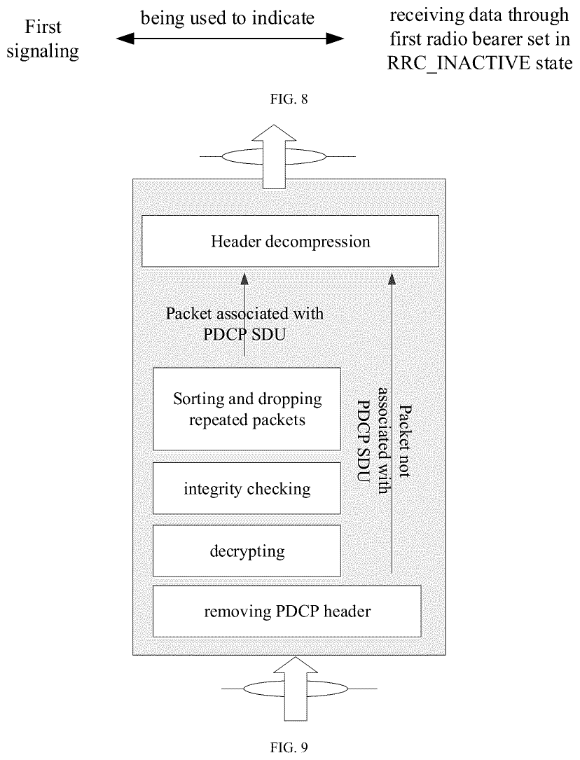

Embodiment 8 illustrates a schematic diagram of a first signaling being used to indicate receiving data through a first radio bearer in RRC_INACTIVE state according to one embodiment of the present application, as shown in FIG. 8.

In one embodiment, the first signaling explicitly indicates whether a header compression state for the first radio bearer is stored.

In one embodiment, the first signaling explicitly indicates whether a header compression state for the first radio bearer is restored.

In one embodiment, the first signaling explicitly indicates receiving data through a first radio bearer in RRC_INACTIVE state.

In one embodiment, the first signaling explicitly indicates receiving a first service through a first radio bearer in RRC_INACTIVE state.

In one embodiment, the meaning of the phrase that a first signaling is used to indicate receiving data through a first radio bearer in RRC_INACTIVE state comprises: an execution of the first signaling will not suspend the first radio bearer.

In one embodiment, the meaning of the phrase that a first signaling is used to indicate receiving data through a first radio bearer in RRC_INACTIVE state comprises: the first signaling indicates not suspending the first radio bearer.

In one embodiment, the meaning of the phrase that a first signaling is used to indicate receiving data through a first radio bearer in RRC_INACTIVE state comprises: the first signaling indicates receiving a first service, the first service is carried by the first radio bearer.

In one embodiment, the meaning of the phrase that a first signaling is used to indicate receiving data through a first radio bearer in RRC_INACTIVE state comprises: a first service belongs to services in a service list supported to be received in RRC_INACTIVE state, and the first service is associated with the first radio bearer or is received through the first radio bearer.

In one embodiment, the meaning of the phrase that a first signaling is used to indicate receiving data through a first radio bearer in RRC_INACTIVE state comprises: the first signaling comprises at least one parameter for using the first radio bearer to receive data in RRC_INACTIVE state.

In one embodiment, an SIB message transmitted by the network indicates a configuration of the first radio bearer; the first radio bearer can be used or received in RRC_INACTIVE state.

In one embodiment, the first signaling comprises an identity or index of the first radio bearer.

### Embodiment 9

Embodiment 9 illustrates a schematic diagram of PDCP function according to one embodiment of the present application, as shown in FIG. 9.

FIG. 9 illustrates the functions of a PDCP, a first radio bearer in the present application is only associated with a PDCP entity, and partial functions in the PDCP entity in FIG. 9 are optional, a PDCP entity corresponding to the first radio bearer in the present application at least uses header compression function.

Embodiment 9 is based on embodiment 3.

FIG. 9 illustrates the functions of PDCP related to reception.

In one embodiment, the first radio bearer is only associated with one RLC entity.

In one embodiment, the first radio bearer is associated with two RLC entities, and after entering into RRC_INACTIVE state, one of the RLC entities is suspended.

In one embodiment, the first radio bearer does not use integrity check and decryption.

In one embodiment, any radio bearer in the first radio bearer set does not use integrity check and decryption.

In one embodiment, header compression is a function of a PDCP entity or PDCP layer.

In one embodiment, header compression belongs to a PDCP.

In one embodiment, a packet associated with the PDCP service data unit (SDU) comprises a SDAP protocol data unit (PDU).

In one embodiment, a packet associated with a PDCP SDU comprises an IP packet.

In one embodiment, a packet not associated with a PDCP SDU comprises a control signaling of a PDCP layer.

In one embodiment, a packet not associated with a PDCP SDU comprises a signaling used for controlling header compression.

### Embodiment 10

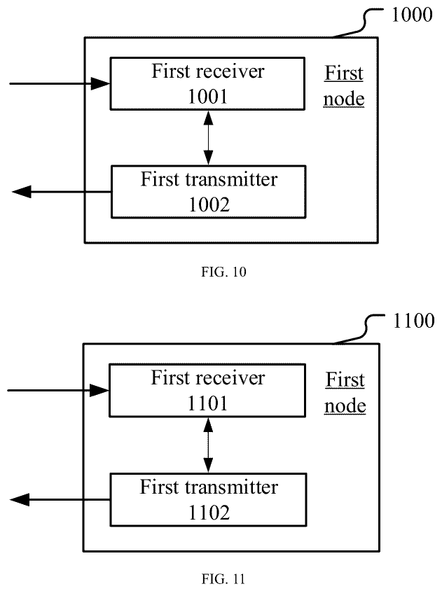

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002. In Embodiment 10,
the first receiver 1001 receives a first signaling in RRC_CONNECTED state, as a response to receiving the first signaling, executes a first operation set, enters into RRC_INACTIVE state; receives data through a first radio bearer in RRC_INACTIVE state;
herein, the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

In one embodiment, the first signaling is used to indicate receiving data through the first radio bearer set in RRC_INACTIVE state; the first radio bearer set comprises at least the first radio bearer.

In one embodiment, only when data is received through the first radio bearer in RRC_INACTIVE state, the phrase that “when the first radio bearer is a multicast radio bearer, the first information does not comprise a header compression state for the first radio bearer” is valid.

In one embodiment, a PDCP entity corresponding to the first radio bearer is configured with header compression, and a profile of the header compression configured to a PDCP entity corresponding to the first radio bearer is a profile other than no compression.

In one embodiment, the first receiver 1001, before receiving the first signaling, receives data through the first radio bearer in RRC_CONNECTED state.

In one embodiment, any radio bearer in the first radio bearer set is a multicast radio bearer for multicast; a second radio bearer is a radio bearer other than the first radio bearer set, and the second radio bearer is a multicast radio bearer for broadcast; the first information does not comprise a header compression state for the first radio bearer.

In one embodiment, the first transmitter 1002 transmits a first message, and the first message is used to request resuming an RRC connection; accompanying a transmission of the first message, restores second information from the first inactive context, the second information comprises the first key;
herein, whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

In one embodiment, the phrase that when the first radio bearer is a multicast radio bearer, the second information does not comprise a header compression state for the first radio bearer is valid only when the first radio bearer is in RRC_INACTIVE state.

In one embodiment, the first receiver 1001 receives a first indication, and the first indication is used to determine whether to stop receiving data through the first radio bearer; a header compression state for the first radio bearer is stored in a first inactive context.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

### Embodiment 11

Embodiment 11 illustrates a structure block diagram of a processor in a first node according to one embodiment of the present application, as shown in FIG. 11. In FIG. 11, a processor 1100 in a first node comprises a first receiver 1101 and a first transmitter 1102. In Embodiment 11,
the first receiver 1101 receives a first signaling, as a response to receiving the first signaling, executes a first operation set, enters into RRC_INACTIVE state;
herein, the first operation set comprises storing first information in a first inactive context, and whether the first information comprises a header compression state for the first radio bearer and whether an execution of the first signaling suspends the first radio bearer; when an execution of the first signaling suspends the first radio bearer, the first information comprises a header compression state for the first radio bearer; when an execution of the first signaling does not suspend the first radio bearer, the first information does not comprise a header compression state for the first radio bearer.

In one embodiment, the first signaling is received in RRC_CONNECTED state.

In one embodiment, the first information comprises a first key, and the first key is used to encrypt the first signaling.

In one embodiment, the first receiver 1101 receives data through the first radio bearer in RRC_INACTIVE state, and the first information does not comprise a header compression state for the first radio bearer.

In one embodiment, the first radio bearer is not SRB0.

In one embodiment, the first signaling is used to indicate receiving data through the first radio bearer set in RRC_INACTIVE state; the first radio bearer set comprises at least the first radio bearer; the first information does not comprise a header compression state for the first radio bearer.

In one embodiment, only when data is received through the first radio bearer in RRC_INACTIVE state, the phrase that “when an execution of the first signaling does not suspend the first radio bearer, the first information does not comprise a header compression state for the first radio bearer” is valid.

In one embodiment, a PDCP entity corresponding to the first radio bearer is configured with header compression, and a profile of the header compression configured to a PDCP entity corresponding to the first radio bearer is a profile other than no compression.

In one embodiment, the first receiver 1101, before receiving the first signaling, receives data through the first radio bearer in RRC_CONNECTED state.

In one embodiment, only when the first radio bearer is a non-unicast bearer, the phrase that “when an execution of the first signaling does not suspend the first radio bearer, the first information does not comprise a header compression state for the first radio bearer” is valid.

In one embodiment, the first transmitter 1102 transmits a first message, and the first message is used to request resuming an RRC connection; accompanying a transmission of the first message, restores second information from the first inactive context;
herein, whether the second information comprises a header compression state for the first radio bearer is related to whether the first radio bearer is suspended; when the first radio bearer is suspended, the second information comprises a header compression state for the first radio bearer; when the first radio bearer is not suspended, the second information does not comprise a header compression state for the first radio bearer.

In one embodiment, the meaning of the phrase that an execution of the first signaling does not suspend the first radio bearer is: receiving data through the first radio bearer in RRC_INACTIVE state.

In one embodiment, the meaning of the phrase that an execution of the first signaling does not suspend the first radio bearer is: before the first radio bearer is continued, data is not received through the first radio bearer in RRC_INACTIVE state.

In one embodiment, the second information comprises the first key.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

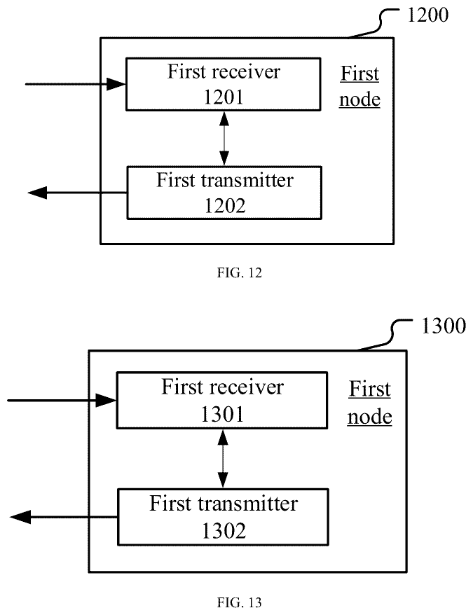

Embodiment 12 illustrates a structure block diagram of a processor in a first node according to one embodiment of the present application, as shown in FIG. 12. In FIG. 12, a processor 1200 in a first node comprises a first receiver 1201 and a first transmitter 1202. In Embodiment 12,
the first receiver 1101 receives a first signaling, as a response to receiving the first signaling, executes a first operation set, enters into RRC_INACTIVE state;
herein, the first operation set comprises storing first information in a first inactive context; for a radio bearer in the first radio bearer set, the first information only comprises a state of a former of a compressor and a decompressor of header compression.

In one embodiment, the first signaling is received in RRC_CONNECTED state.

In one embodiment, the first information comprises a first key, and the first key is used to encrypt the first signaling.

In one embodiment, the first radio bearer set comprises a first radio bearer.

In one embodiment, the first receiver 1201 receives data through the first radio bearer in RRC_INACTIVE state, and the first information does not comprise a header compression state for the first radio bearer.

In one embodiment, the first radio bearer is not SRB0.

In one embodiment, the first radio bearer is a radio bearer other than any SRB0.

In one embodiment, the first radio bearer is any non-signaling radio bearer configured with header compression.

In one embodiment, the first signaling is used to indicate receiving data through the first radio bearer set in RRC_INACTIVE state; the first radio bearer set comprises at least the first radio bearer; the first information does not comprise a header compression state for the first radio bearer.

In one embodiment, the first receiver 1201, before receiving the first signaling, receives data through the first radio bearer in RRC_CONNECTED state.

In one embodiment, the first radio bearer set only comprises a radio bearers other than an SRB.

In one embodiment, the first radio bearer set only comprises a DRB and an MRB.

In one embodiment, the first radio bearer set only comprises an MRB.

In one embodiment, the second radio bearer set comprises at least one radio bearer, and the second radio bearer set is orthogonal to the first radio bearer set; for a radio bearer in a second radio bearer set, the first information comprises a state of a compressor and a state of a decompressor of header compression.

In one embodiment, the second radio bearer set comprises a DRB.

In one embodiment, the first transmitter 1202 transmits a first message, and the first message is used to request resuming an RRC connection; accompanying a transmission of the first message, restores second information from the first inactive context;
herein, the second information comprises a header compression state for the first radio bearer.

In one embodiment, the second information comprises a header compression state for any radio bearer in the first radio bearer set.

In one embodiment, the second information comprises a header compression state for any radio bearer in the second radio bearer set.

In one embodiment, the second information comprises the first key.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

### Embodiment 13

Embodiment 13 illustrates a structure block diagram of a processor in a first node according to one embodiment of the present application, as shown in FIG. 13. In FIG. 13, a processor 1300 of a first node comprises a first receiver 1301 and a first transmitter 1302. In Embodiment 13,
the first transmitter 1302 transmits a first message, and the first message is used to request resuming an RRC connection; accompanying a transmission of the first message, restores second information from the first inactive context;
herein, whether the second information comprises a header compression state for the first radio bearer is related to whether the first radio bearer is suspended; when the first radio bearer is suspended, the second information comprises a header compression state for the first radio bearer; when the first radio bearer is not suspended, the second information does not comprise a header compression state for the first radio bearer.

In one embodiment, the first radio bearer is any radio bearer in a first radio bearer set.

In one embodiment, the second information comprises a header compression state for any radio bearer in the first radio bearer set.

In one embodiment, the second information comprises a header compression state for any radio bearer in the second radio bearer set.

In one embodiment, the second information comprises the first key.

In one embodiment, the first receiver 1301, before the first message is transmitted, receives a first signaling, as a response to receiving the first signaling, executes a first operation set, enters into RRC_INACTIVE state;
herein, the first operation set comprises storing first information in a first inactive context.

In one embodiment, the first signaling is received in RRC_CONNECTED state.

In one embodiment, the first information comprises a header compression state of the first radio bearer.

In one embodiment, whether the first information comprises a header compression state for the first radio bearer and whether an execution of the first signaling suspends the first radio bearer; when an execution of the first signaling suspends the first radio bearer, the first information comprises a header compression state for the first radio bearer; when an execution of the first signaling does not suspend the first radio bearer, the first information does not comprise a header compression state for the first radio bearer.

In one embodiment, the first information comprises a first key, and the first key is used to encrypt the first signaling.

In one embodiment, the first receiver 1301 receives data through the first radio bearer in RRC_INACTIVE state.

In one subembodiment of the embodiment, the first information does not comprise a header compression state for the first radio bearer.

In one embodiment, the first radio bearer is not SRB0.

In one embodiment, the first radio bearer is a radio bearer other than any SRB0.

In one embodiment, the first radio bearer is any non-signaling radio bearer configured with header compression.

In one embodiment, the first signaling is used to indicate receiving data through the first radio bearer set in RRC_INACTIVE state; the first radio bearer set comprises at least the first radio bearer; the first information does not comprise a header compression state for the first radio bearer.

In one embodiment, the first receiver 1301, before receiving the first signaling, receives data through the first radio bearer in RRC_CONNECTED state.

In one embodiment, the first radio bearer set only comprises a radio bearer other than an SRB.

In one embodiment, the first radio bearer set only comprises a DRB and an MRB.

In one embodiment, the first radio bearer set only comprises an MRB.

In one embodiment, the second information comprises the first key.

In one embodiment, the phrase that when the first radio bearer is not suspended, the second information does not comprise a header compression state for the first radio bearer, is valid only when the first message is transmitted for entering RRC_CONNECTED state.

In one embodiment, the phrase that when the first radio bearer is not suspended, the second information does not comprise a header compression state for the first radio bearer, is independent on the purpose of the first message.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling in radio resource control (RRC)_CONNECTED state, as a response to receiving the first signaling, executing a first operation set, entering into RRC_INACTIVE state; receiving data through a first radio bearer in RRC_INACTIVE state;
wherein the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.

2. The first node according to claim 1, wherein
the first signaling is used to indicate receiving data through the first radio bearer set in RRC_INACTIVE state; the first radio bearer set comprises at least the first radio bearer.

3. The first node according to claim 1, wherein
only when data is received through the first radio bearer in RRC_INACTIVE state, the phrase that “when the first radio bearer is a multicast radio bearer, the first information does not comprise a header compression state for the first radio bearer” is valid.

4. The first node according to claim 2, wherein
only when data is received through the first radio bearer in RRC_INACTIVE state, the phrase that “when the first radio bearer is a multicast radio bearer, the first information does not comprise a header compression state for the first radio bearer” is valid.

5. The first node according to claim 1, wherein
a Packet Data Convergence Protocol (PDCP) entity corresponding to the first radio bearer is configured with header compression, and a profile of the header compression configured to a PDCP entity corresponding to the first radio bearer is a profile other than no compression.

6. The first node according to claim 3, wherein
a PDCP entity corresponding to the first radio bearer is configured with header compression, and a profile of the header compression configured to a PDCP entity corresponding to the first radio bearer is a profile other than no compression.

7. The first node according to claim 4, wherein
a PDCP entity corresponding to the first radio bearer is configured with header compression, and a profile of the header compression configured to a PDCP entity corresponding to the first radio bearer is a profile other than no compression.

8. The first node according to claim 1, comprising:
the first receiver, before receiving the first signaling, receiving data through the first radio bearer in RRC_CONNECTED state.

9. The first node according to claim 1, wherein
any radio bearer in the first radio bearer set is a multicast radio bearer for multicast; a second radio bearer is a radio bearer other than the first radio bearer set, and the second radio bearer is a multicast radio bearer for broadcast; the first information does not comprise a header compression state for the first radio bearer.

10. The first node according to claim 1, comprising:
the first transmitter, transmitting a first message, and the first message being used to request resuming an RRC connection; accompanying a transmission of the first message, restoring second information from the first inactive context, the second information comprising the first key;
wherein whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

11. The first node according to claim 3, comprising:
the first transmitter, transmitting a first message, and the first message being used to request resuming an RRC connection; accompanying a transmission of the first message, restoring second information from the first inactive context, the second information comprising the first key;
wherein whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

12. The first node according to claim 5, comprising:
the first transmitter, transmitting a first message, the first message being used to request resuming an RRC connection; accompanying a transmission of the first message, restoring second information from the first inactive context, the second information comprising the first key;
wherein whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

13. The first node according to claim 6, comprising:
the first transmitter, transmitting a first message, the first message being used to request resuming an RRC connection; accompanying a transmission of the first message, restoring second information from the first inactive context, the second information comprising the first key;
wherein whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

14. The first node according to claim 7, comprising:
the first transmitter, transmitting a first message, the first message being used to request resuming an RRC connection; accompanying a transmission of the first message, restoring second information from the first inactive context, the second information comprising the first key;
wherein whether the second information comprises a header compression state for the first radio bearer is related to a type of the first radio bearer; when the first radio bearer is not a multicast radio bearer, the second information comprises a header compression state for the first radio bearer; when the first radio bearer is a multicast radio bearer, the second information does not comprise a header compression state for the first radio bearer.

15. The first node according to claim 14, wherein
the phrase that when the first radio bearer is a multicast radio bearer, the second information does not comprise a header compression state for the first radio bearer is valid only when the first radio bearer is in RRC_INACTIVE state.

16. The first node according to claim 1, comprising:
the first receiver, receiving a first indication, the first indication being used to determine stopping receiving data through the first radio bearer; storing a header compression state for the first radio bearer in a first inactive context.

17. The first node according to claim 1, wherein
the first signaling indicates a nextHopChainingCount, and the nextHopChainingCount is used to generate key.

18. The first node according to claim 1, wherein
the multicast radio bearer is a radio bearer configured for MB S multicast or broadcast transmission, and the first radio bearer is a radio bearer other than signaling radio bearer 0 (SRB0).

19. The first node according to claim 1, wherein
a PDCP corresponding to the first radio bearer only has one decompressor instance for header compression.

20. A method in a first node for wireless communications, comprising:
receiving a first signaling in RRC_CONNECTED state, as a response to receiving the first signaling, executing a first operation set, entering into RRC_INACTIVE state; receiving data through a first radio bearer in RRC_INACTIVE state;
wherein the first operation set comprises storing first information in a first inactive context, the first information comprises a first key, and the first key is used to encrypt the first signaling; whether the first information comprises a header compression state for the first radio bearer is related to a type of the first radio bearer; when the first radio bearer is not a multicast radio bearer, the first information comprises a header compression state for the first radio bearer; when the first radio bearer is a multicast radio bearer, the first information does not comprise a header compression state for the first radio bearer.
